(19) United States
(12) Patent Application Publication
(10) Pub. No.: US 2004/0246339 A1
(43) Pub. Date: Dec. 9, 2004

(54) Network-connected camera and image display method

(76) Inventors: Isao Ooshima, Kawasaki-shi (JP); Hiroshi Yoshimura, Saitama-shi (JP); Yasuhito Ambiru, Ome-shi (JP)

Correspondence Address: Finnegan, Henderson, Farabow,, Garrett & Dunner, L.L.P., 1300 I Street, N.W., Washington, DC, 20005-3315, US

(21) Appl. No.: 10/805,248

(22) Filed: Mar. 22, 2004

(30) Foreign Application Priority Data
Mar. 31, 2003 (JP) 2003-096302

(51) Int. Cl. H04N 7/14

(52) U.S. Cl. 348/207.1

(57) ABSTRACT

A network-connected camera comprising a retrieval message sending unit configured to send a retrieval message that contains the position information of the camera itself over a network at regular intervals, a return message sending unit configured to, upon detecting a retrieval message sent over the network, send a return message containing the position information of the camera itself over the network, and a position information recording unit configured to, upon detecting a retrieval message and a return message sent over the network, record the position information contained in the retrieval message and the return message.

### CROSS-REFERENCE TO RELATED APPLICATIONS

This application is based upon and claims the benefit of priority from the prior Japanese Patent Application No. 2003-096302, filed Mar. 31, 2003, the entire contents of which are incorporated herein by reference.

### BACKGROUND OF THE INVENTION

1. Field of the Invention

The present invention relates to a network-connected camera and an image display method which are suitable for use with a monitoring system that uses a number of cameras.

2. Description of the Related Art

As is well known, a conventional monitoring system is configured such that a personal computer (PC) on the client side receives images captured by a number of cameras over a network and displays them on a display screen in a multi-image display form.

In this case, the images captured by the cameras are displayed in a multi-image display form on a time-division basis by entering the network addresses of the cameras into the PC in advance so that the PC can access each camera in sequence on the basis of the input addresses.

With such a network-based multi-image display system, however, each time the number of cameras on the network is increased or reduced, a change (addition or deletion) must be made to the addresses of the cameras entered into the PC.

In addition, with the multi-image display system, a layout for the multi-image display is set beforehand in the PC according to the number of cameras connected to the network.

For this reason, each time the cameras on the network are increased or reduced in number, there also arises a need to change the multi-image display layout.

Here, Japanese Unexamined Patent Publication No. 2003-9132 discloses a camera monitoring system in which images captured by a number of cameras are sent over a network to a client's Web browser and displayed.

In this camera monitoring system, icons are displayed by the web browser to conform to the positions in which the cameras are placed and, when a desired icon is clicked by the client, the image captured by the camera corresponding to that icon is displayed.

The system disclosed in the above patent publication is adapted to, when a change is made to the number of the cameras or the positions of the cameras, allow the client to readily change the positions in which the icons are displayed on the Web browser.

However, the above patent publication discloses no technique of displaying images captured by a number of cameras in a multi-image display form. It is therefore apparent that the patent publication is irrelevant to the solution of the problems with the aforementioned multi-image display system.

### BRIEF SUMMARY OF THE INVENTION

According to one aspect of the present invention, there is provided a network-connected camera comprising: a retrieval message sending unit configured to send a retrieval message that contains the position information of the camera itself over a network at regular intervals; a return message sending unit configured to, upon detecting a retrieval message sent over the network, send a return message containing the position information of the camera itself over the network; and a position information recording unit configured to, upon detecting a retrieval message and a return message sent over the network, record the position information contained in the retrieval message and the return message.

According to another aspect of the present invention, there is provided an image display method comprising: obtaining over a network first information that specifies a layout for multi-image display and second information that specifies a number of cameras which provides images which are to be displayed on divided display areas indicated by the layout specified by the first information; dividing a display screen into a number of display areas on the basis of the layout specified by the first information; obtaining image signals from the cameras specified by the second information over the network; and displaying the image signals obtained from the cameras over the network on the divided display areas, respectively, of the display screen.

### BRIEF DESCRIPTION OF THE SEVERAL VIEWS OF THE DRAWING

FIG. 1 is a schematic illustration of a monitoring system in accordance with an embodiment of the present invention;

FIG. 2 is a block diagram of the signal processing system of a camera according to the embodiment of the present invention;

FIG. 3 is a diagram for use in explanation of the automatic camera search operation on the network according to the embodiment of the present invention;

FIG. 4 is a flowchart for use in explanation of the multi-image display operation according to the embodiment of the present invention;

FIG. 5 is a diagram for use in explanation of one example of a multi-image display layout according to the embodiment of the present invention;

FIG. 6 shows a modification of the monitoring system according to the embodiment of the present invention; and

FIG. 7 is a diagram for use in explanation of another example of a multi-image display layout according to the embodiment of the present invention.

### DETAILED DESCRIPTION OF THE INVENTION

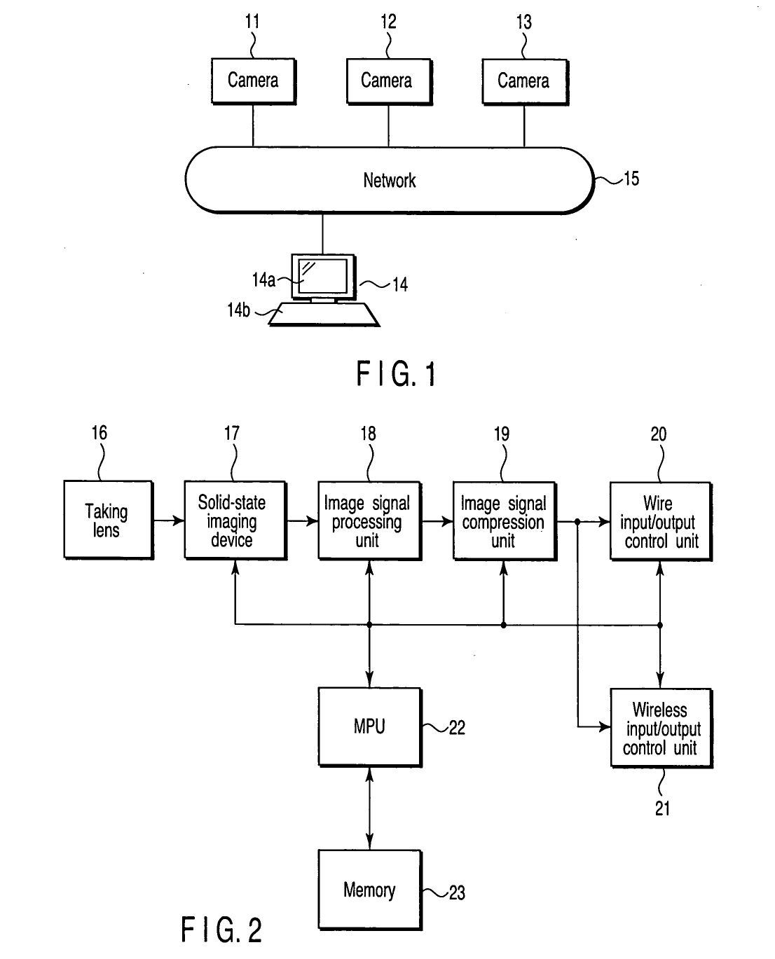

An embodiment of the present invention will be described in detail hereinafter with reference to the accompanying drawings. FIG. 1 is a schematic illustration of a monitoring system described as the embodiment of the present invention. Of course, the present invention is not limited only to the monitoring system.

The monitoring system is configured such that a number of cameras 11, 12, and 13 (three in the drawing) and a client's PC 14 equipped with an image display unit 14a and an operating unit 14b are interconnected on a network 15.

With this monitoring system, the TCP/IP (Transmission Control Protocol/Internet Protocol) is used in the network 15, allowing data communications among the cameras 11, 12 and 13 and the PC 14. The data communications over the network 15 can be made either by cable or by radio.

In this case, each of the cameras 11, 12 and 13 is assigned an IP address as information indicating the position by a DHCP (Dynamic Host Configuration Protocol) server connected to the network 15.

Each of the cameras 11, 12 and 13 is allowed to access the other cameras connected to the same network 15 as it is connected through an automatic camera retrieval protocol (RNCP: Retrieve Neighbory Cameras Protocol) in order to acquire their respective IP addresses.

By applying an application dedicated to camera retrieval to the network 15, the PC 14 is allowed to selectively access each of the cameras 11, 12 and 13 and make data communications with the accessed one.

FIG. 2 shows the signal processing system of the camera 11. The other cameras 12 and 13 have the same signal processing system as the camera 11 and hence the description thereof is omitted.

That is, an optical image of a subject is formed through a taking lens 16 onto a solid state imaging device 17, such as a CCD (Charge Coupled Device), and converted into an electrical image signal corresponding to the optical image.

The image signal output from the solid state imaging device 17 is applied to an image signal processing unit 18 which performs predetermined image signal processing on the input image signal and then applied to an image signal compression unit 19 which performs, for example, MPEG (Moving Picture Experts Group)-based image signal compression processing on the input image signal.

The image signal output from the image signal compression unit 19 is applied to a wire input/output control unit 20 by which the input image signal is sent over the wire network 15. Also, the image signal output from the image signal compression unit 19 is applied to a wireless input/output control unit 21 by which the input image signal is sent over the wireless network 15.

The above series of imaging operations is controlled by an MPU (Micro Processing Unit) 22. The MPU 22 is adapted to control each component on the basis of control programs and various settings stored in a memory 23 with the memory 23 used as a work area.

The MPU 22 is capable of making data communications with the other cameras 12 and 13 and the PC 14 via the wire input/output control unit 20 and the wireless input/output control unit 21.

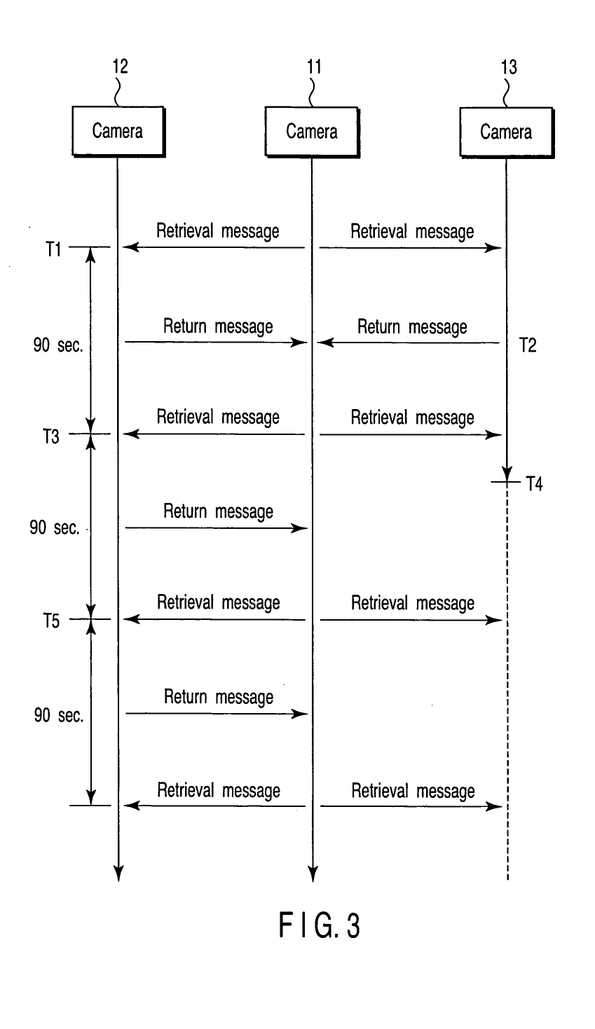

FIG. 3 shows an operation when the camera 11 automatically accesses the other cameras 12 and 13 connected to the same network 15 as it is connected through the automatic camera retrieval protocol (RNCP).

First, at time T1 the MPU 22 in the camera 11 sends a retrieval message (RNCPDISCOVER message) over the network 15. The retrieval message contains the IP address of the camera 11.

Upon detecting the retrieval message sent from the camera 11 connected to the network 15, each of the other cameras 12 and 13 sends a return message (RNCPHELLO message) over the network 15 at time T2 before a specified length of time (for example, 90 seconds) elapses after the time Ti the retrieval message was sent.

In this case, each of the cameras 12 and 13 acquires and records the IP address of the camera 11 contained in the retrieval message sent therefrom. Each of the cameras 12 and 13 inserts its IP address into the corresponding return message.

Upon detecting the return messages sent over the network 15 from the cameras 12 and 13, therefore, the MPU 22 of the camera 11 acquires and records the IP addresses of the cameras 12 and 13 contained in their return messages. This allows the MPU 22 of the camera 11 to know that the cameras 12 and 13 exist on the same network 15.

The MPU 22 of the camera 11 repeats an operation of knowing the existence of the other cameras 12 and 13 by sending a retrieval message over the network 15 at regular intervals of a given time (for example, 90 seconds) and detecting return messages for the sent retrieval message.

Suppose here that the camera 13 is removed from the network 15 at a certain time, for example, at time T4 after the MPU 22 of the camera 11 sent a retrieval message over the network 15 at time T3.

Then, the MPU 22 of the camera 11 will not obtain a return message from the camera 13 for the retrieval message sent at time T3 and moreover will not receive a return message for a retrieval message sent at time T5 subsequent to time T3.

Upon failure to receive a return message from the camera 13 for each of the two retrieval messages sent in succession, the MPU 22 of the camera 11 determines that the camera 13 has been removed from the network 15 and then deletes the IP address of the camera 13 from the memory 23.

In this way, the MPU 22 of the camera 11 detects the presence or absence of the other cameras 12 and 13 on the network 15 at regular intervals. Thereby, the MPU 22 of the camera 11 is allowed to readily know an increase or reduction in the number of the other cameras on the network 15.

Also, by accessing the camera 11 and looking through the contents of the memory 23, the PC 14 is allowed to recognize all other cameras 12 and 13 connected to the network 15.

Each of the cameras 12 and 13 likewise detects and records the existence of the other cameras by sending a retrieval message and detecting a return message for it. That is, the cameras 11, 12 and 13 connected to the network 15 are adapted to be able to recognize one another.

For this reason, the PC 14 can access any one of the cameras 11, 12 and 13 to recognize all other cameras 12 and 13 connected to the network 15.

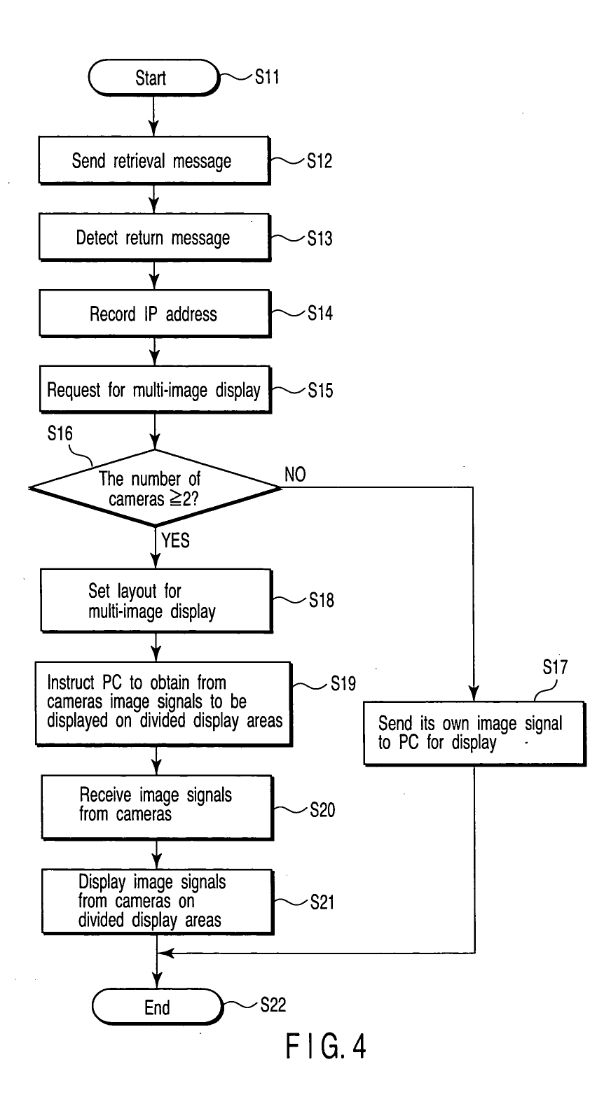

FIG. 4 is a flowchart in which the operation of the camera 11 to recognize the other cameras 12 and 13 and the operation of the PC 14 to access the camera 11 are taken together.

First, when the operation is started (step S11), the MPU 22 of the camera 11 sends a retrieval message over the network 15 in step S12. Upon detecting a return message sent over the network 15 in step S13, the MPU 22 of the camera 11 records the IP address contained in the detected return message in step S14.

The operations in steps S12, S13 and S14 are performed repeatedly at regular intervals as an automatic camera retrieval operation.

In such a state, when accessed by and a request for multi-image display is made by the PC 14 in step S15, the MPU 22 of the camera 11 refers to the contents of the memory 23 to make a decision of whether or not the number of cameras currently connected to the network 15 is two or more, including the camera 11, in step S16.

If the decision is that the number of cameras currently connected to the network 15 is neither two nor more (NO in step S16), then the MPU 22 of the camera 11 sends its image signal over the network 15 to the PC 14 and causes the PC to display it on the display unit 14a in step S17. Then, the procedure is completed (step S22).

If, on the other hand, the decision is that the number of cameras currently connected to the network 15 is two or more (YES in step S16), then the MPU 22 of the camera 11 sets up a multi-image display layout according to the number of the cameras in step S18.

As multi-image display layouts, there have been prepared a mode in which the display screen of the image display unit 14a of the PC 14 is divided by two in each of horizontal and vertical directions into four display areas, a mode in which the display screen is divided by three in each of horizontal and vertical directions into nine display areas, and a mode in which the display screen is divided by four in each of horizontal and vertical directions into sixteen display areas.

In step S18, one of the modes is selected according to the number of the cameras. Since, in this embodiment, three cameras 11, 12 and 13 are connected to the network 15, the four-image mode is selected and the associated mode information is sent to the PC 14.

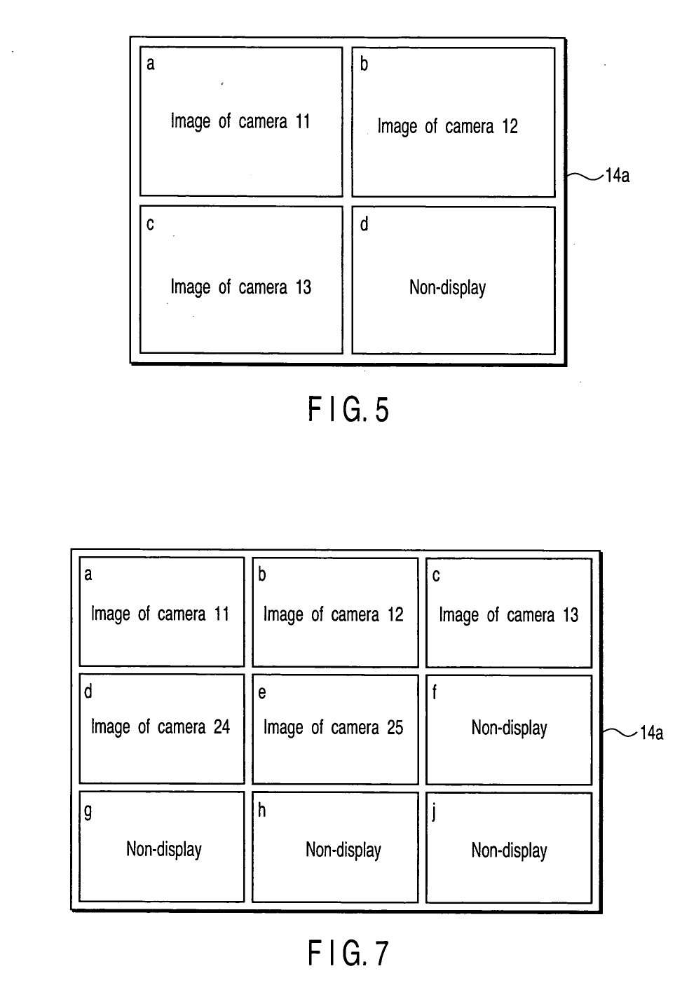

For this reason, the PC 14 divides the display screen of the image display unit 14a into four display areas a, b, c, and d as shown in FIG. 5 in accordance with the mode information sent from the camera 11.

After that, the MPU 22 of the camera 11 instructs the PC 14 to obtain from the cameras 11, 12 and 13 image signals which are to be displayed on the four divided display areas a, b, c and d of the display screen of the image display unit 14a in step S19.

In this case, the MPU 22 of the camera 11 instructs the PC 14 to obtain an image signal that is to be displayed on the display area a from the camera 11, obtain an image signal that is to be displayed on the display area b from the camera 12, obtain an image signal that is to be displayed on the display area c from the camera 13, and sets the area d to the non-display state.

In subsequent step S20, the PC 14 causes each of the cameras 11, 12 and 13 to send an image signal in step S20, then displays images captured by the cameras 11, 12 and 13 on the display areas a, b, and c, respectively, of the image display unit 14 and sets area d to the non-display state in step S21. Then, the procedure is complete (step S22).

According to the embodiment described above, the automatic camera retrieval protocol allows all the cameras 11, 12 and 13 to recognize one another and each of them to record the IP addresses of the other cameras.

For this reason, in order to allow all the cameras 11, 12 and 13 connected to the network 15 to be recognized readily, the PC 14 simply accesses a certain camera and reads the IP addresses of the other cameras recorded in that camera.

The operation of each of the cameras 11, 12 and 13 to recognize the other cameras is carried out at regular intervals and the recorded information is updated in accordance with the results of recognition, thus allowing a camera or cameras that are newly connected to or are removed from the network 15 to be recognized readily.

Thereby, the user is released from the necessity of performing an operation of adding or deleting an IP address or addresses on the PC 14 each time a change is made to the number of cameras on the network 15. The user is therefore allowed to know correctly the cameras existing on the network 15 with no need to perform a troublesome operation.

When selected by the PC 14 for a request for multi-image display, the MPU of a certain camera presents to the PC information indicating a layout for multi-image display corresponding to the number of cameras connected to the network 15 and information indicating assignment of the cameras to the divided display areas determined by that layout.

For this reason, by simply accessing a certain camera and making a request for multi-screen display on it, the PC 14 can readily display images captured by the cameras in a multi-screen display form on the basis of the layout information presented from that camera without performing a complicated operation.

In the operation shown in FIG. 4, the MPU 22 of the camera 11 has been described as sending information indicating a layout for multi-image display to the PC 14 in step S18 and then instructing the PC 14 to obtain images to be displayed on the divided display areas a, b and c from the cameras 11, 12 and 13 in step S19.

However, this is not restrictive. The operation may be modified such that, in step S18, the MPU 22 of the camera 11 sends to the PC 14 an image signal captured by itself and an instruction to display the image signal on the display area a when sending the information indicating the layout for multi-image display and, in subsequent step S19, sends an instruction to the PC 14 to obtain images to be displayed on the divided display areas b and c from the cameras 12 and 13.

Suppose here that, in a state where such a multi-image screen as shown in FIG. 5 is appearing on the display screen as the result of access by the PC 14 to the camera 11, the camera 13 is removed from the network 15 as described in connection with FIG. 3.

In this case, upon detecting that the camera 13 has been removed from the network 15, the MPU 22 of the camera 11 sends to the PC 14 an instruction to set the display area c to the non-display state.

For this reason, the client can recognize that the camera 13 has been removed from the network 15 as the result of the display area c on which the image captured by the camera 13 had been displayed having been set to the non-display state.

When detecting that the camera 13 has been removed from the network 15, the MPU 22 of the camera 11 may cause the PC 14 to display a message to that effect.

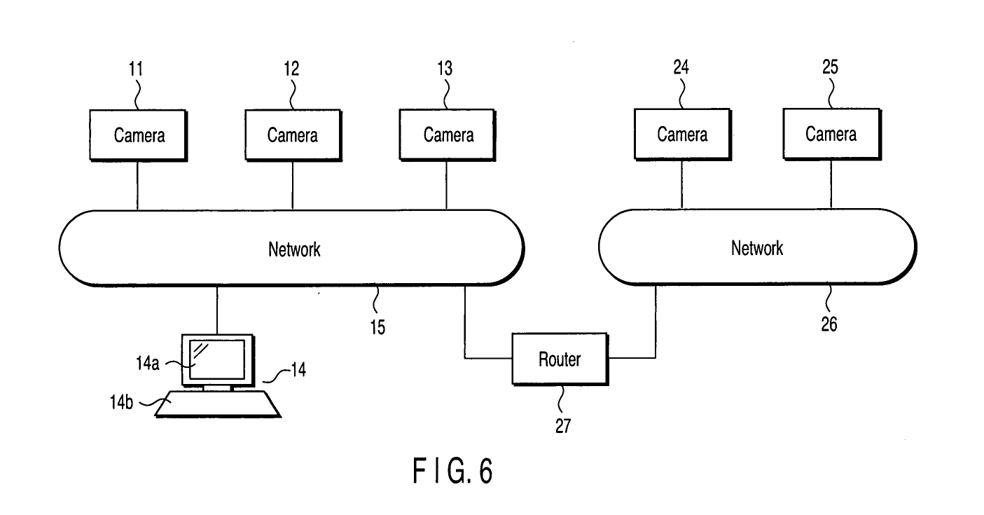

FIG. 6 shows a modification of the embodiment described above. That is, a network 26 to which cameras 24 and 25 are connected is connected by a router 27 to the network 15 of FIG. 1 to which the cameras 11, 12 and 13 are connected.

In this case, since the automatic camera retrieval protocol (RNCP) that functions on the network 15 cannot function beyond the router 27, the PC 14 cannot access the cameras 24 and 25 connected to the network 27. That is, the cameras 11, 12 and 13 on the network 15 cannot recognize the cameras 24 and 25 on the network 27.

In such a case, the client records the IP addresses of the cameras 24 and 25 connected to the network 27 into each of the cameras 11, 12 and 13 connected to the network 15 with manual processing.

In such a situation, by accessing the camera 11 by way of example and looking through the stored contents of its memory 23, the PC 14 is allowed to recognize that the cameras 11, 12, 13, 24 and 25 are connected to the networks 15 and 26.

Suppose here that the PC 14 accesses the camera 11 to make a request for multi-image display. In this case, since the total number of cameras is five, the MPU 22 of the camera 11 selects the nine-image mode as a layout for multi-image display and sends the associated mode information to the PC 14.

In response to the mode information sent from the camera 11, the PC 14 divides the display screen of the display unit 14a into nine areas a, b, c, d, e, f, g, h, and i as shown in FIG. 7.

After that, the MPU 22 of the camera 11 instructs the PC 14 to obtain from the cameras 11, 12, 13, 24, and 25 images signals which are to be displayed on the nine divided areas a through f of the display screen of the image display unit 14a.

In this case, the MPU 22 of the camera 11 instructs the PC 14 to obtain image signals to be displayed on the display areas a, b, c, d, and e from the cameras 11, 12, 13, 24, and 25, respectively, and set the areas f, g, h, and i to the non-display state.

As the result, images captured by the cameras 11, 12, 13, 24 and 25 are displayed on the display areas a, b, c, d, and e, respectively, of the display screen of the image display unit 14a and the other areas f, g, h, and i are set to the non-display state.

With the embodiment and the modification described above, when a request for multi-image display is made, images captured by all the cameras connected to a network or networks are displayed in a multi-image display form on a display screen.

However, this is not restrictive. For example, it is also possible for the PC 14 to specify some of the cameras and allow images captured only by the specified cameras to be displayed in a multi-image display form.

The present invention is not limited to the above embodiment and modification. At the stage of practice of the invention, constituent components can be variously modified without departing from the scope and spirit thereof. The constituent components disclosed in the above embodiment can be combined appropriately to form various inventions. As an example, some components may be removed from all the constituent components shown in the embodiment.

What is claimed is:

1. A network-connected camera comprising:
a retrieval message sending unit configured to send a retrieval message that contains the position information of the camera itself over a network at regular intervals;
a return message sending unit configured to, upon detecting a retrieval message sent over the network, send a return message containing the position information of the camera itself over the network; and
a position information recording unit configured to, upon detecting a retrieval message and a return message sent over the network, record the position information contained in the retrieval message and the return message.

2. A network-connected camera according to claim 1, wherein the position information recording unit changes the recorded contents on the basis of a detected return message sent over the network in response to the retrieval message sent over the network at regular intervals by the retrieval message sending unit.

3. A network-connected camera according to claim 1, wherein the position information recording unit, upon detecting a new return message sent over the network in response to the retrieval message sent over the network at regular intervals by the retrieval message sending unit, adds position information contained in the new return message to its recorded contents.

4. A network-connected camera according to claim 1, wherein, when a return message for the retrieval message sent over the network at regular intervals by the retrieval message sending unit is not detected over a predetermined number of times, the position information recording unit erases the position information contained in that return information and recorded when it was once detected.

5. A network-connected camera according to claim 1, further comprising an information sending unit configured to, upon receiving a request for multi-image display over the network, send over the network information that allows the multi-image display on the basis of the recorded contents of the position information recording unit.

6. A network-connected camera according to claim 5, wherein the information sending unit sends over the network first information that specifies a layout for the multi-image display and second information that specifies assignment of images captured by cameras connected to the network to divided display areas on a display screen indicated by the layout specified by the first information.

7. A network-connected camera according to claim 6, wherein, upon detecting information that selects cameras which provide images to be displayed on the divided display areas indicated by the layout and is sent over the network, the information sending unit sends over the network information that specifies cameras selected on the basis of that select information.

8. An image display method comprising:
obtaining over a network first information that specifies a layout for multi-image display and second information that specifies a number of cameras which provides images which are to be displayed on divided display areas indicated by the layout specified by the first information;
dividing a display screen into a number of display areas on the basis of the layout specified by the first information;
obtaining image signals from the cameras specified by the second information over the network; and
displaying the image signals obtained from the cameras over the network on the divided display areas, respectively, of the display screen.
